(19) United States
(12) Patent Application Publication
(10) Pub. No.: US 2016/0066192 A1
(43) Pub. Date: Mar. 3, 2016

(54) Methods and Apparatus for Managing Wireless Spectrum Usage

(71) Applicant: Nokia Solutions and Networks GmbH & Co. KG, Espoo (FI)

(72) Inventors: Christian Markwart, Munich (DE); Maximilian Riegel, Nurnberg (DE); Karl-Josef Friederichs, Puchhelm (DE)

(21) Appl. No.: 14/475,763

(22) Filed: Sep. 3, 2014

(51) Int. Cl. H04W 16/14; H04W 12/08

(52) U.S. Cl. CPC H04W 16/14; H04W 12/08; H04L 69/28

(57) ABSTRACT

Improved mechanisms for managing use of shared spectrum resources. A requesting element such as a base station requests authorization for use of shared spectrum resources for one or more base stations. The request suitably includes identification of the cell or cells and the requested resources. A granting element determines if authorization can be granted and sends an authorization acceptance message specifying a grant time or an authorization rejection message specifying a wait time. As an alternative, if no response is received by the requesting element, the requesting element may make further requests separated by a specified timeout time and if no response is received, be inhibited from subsequent requests for a specified response failure time. In addition, a request may be triggered based on the occurrence of specified events.

### TECHNICAL FIELD

The present invention relates generally to wireless communication. More particularly, the invention relates to improved systems and techniques for managing control of and access to specified categories of wireless communication spectrum resources.

### BACKGROUND

The increasing number of wireless network users and their continually increasing demands for service presents a constant threat of spectrum saturation and has led to constant efforts by network operators to increase the available wireless spectrum. Authorized shared access (ASA) (also referred to as licensed shared access (LSA)) spectrum resources are shared between operators under specified rules, and are available for access by wireless network base stations (such as those operating according to standards established under the Third Generation Partnership Project (3GPP) and its various manifestations, including long term evolution (LTE) and LTE-advanced (LTE-A). ASA/LSA spectrum resources supplement licensed and unlicensed spectrum resources. ASA/LSA spectrum resources typically owned by an incumbent (primary operator) who allows other licensed operators (secondary users) to use these spectrum resources for their own purposes. ASA/LSA allows support of different operators by using separated ASA/LSA resources. Each ASA/LSA resource allocation is defined by a specified spectrum band and a time interval and location in which the specified spectrum band may be used. The term “spectrum resource” or “ASA/LSA spectrum resource” may be used to designate a single ASA/LSA spectrum resource or a set of spectrum resources. ASA/LSA spectrum resources are not statically assigned, and must be vacated by a secondary operator upon request by the primary user. ASA/LSA provides for a nonexclusive spectrum allocation, which calls for the development of new management approaches. It will be recognized the present discussion primarily addresses ASA/LSA by way of example, but that the present invention is by no means limited to ASA/LSA and that embodiments of the invention may be employed to advantage in numerous different spectrum resource sharing scenarios.

### SUMMARY

In one embodiment of the invention, a method comprises receiving an authorization request for use of shared spectrum resources by a node of a wireless network communication system, wherein the authorization request specifies at least an identifier which describes the spectrum resource requested. If use of an authorized shared access resource is allowed, a grant time is determined during which the spectrum resource is allowed to be used by the requesting node. An authorization request acceptance is sent, including the identifier of the shared spectrum resource, and specifying the grant time.

In another embodiment of the invention, a method comprises sending an authorization request for use of shared spectrum resources for a node of a wireless communications network. The authorization request includes at least an identification of the shared spectrum resource. Upon receiving an authorization acceptance, Active timers relating to usage of the specified spectrum resource are stopped and use of the specified spectrum resource by the node is activated. A timer is activated, during pendency of which the authorized spectrum resource may be used. The timer runs during the duration of a grant time received in the authorization acceptance.

In another embodiment of the invention, an apparatus comprises at least one processor and memory storing a program of instructions. Execution of the program of instructions by the at least one processor causes an apparatus to at least receive an authorization request for use of shared spectrum resources by a node of a wireless network communication system, wherein the authorization request specifies at least an identifier which describes the spectrum resource requested. If use of an authorized shared access resource is allowed, a grant time is determined during which the spectrum resource is allowed to be used by the requesting node. An authorization request acceptance is sent, including the identifier of the shared spectrum resource, and specifying the grant time.

In another embodiment of the invention, an apparatus comprises at least one processor and memory storing a program of instructions. Execution of the program of instructions by the at least one processor causes an apparatus to at least send an authorization request for use of shared spectrum resources for a node of a wireless communications network. The authorization request includes at least an identification of the shared spectrum resource. Upon receiving an authorization acceptance, active timers relating to usage of the specified spectrum resource are stopped and use of the specified spectrum resource by the node is activated. A timer is activated, during pendency of which the authorized spectrum resource may be used. The timer runs during the duration of a grant time received in the authorization acceptance.

In another embodiment of the invention, a computer readable medium stores a program of instructions. Execution of the program of instructions by a processor configures an apparatus to at least receive an authorization request for use of shared spectrum resources by a node of a wireless network communication system, wherein the authorization request specifies at least an identifier which describes the spectrum resource requested. If use of an authorized shared access resource is allowed, a grant time is determined during which the spectrum resource is allowed to be used by the requesting node. An authorization request acceptance is sent, including the identifier of the shared spectrum resource, and specifying the grant time.

In another embodiment of the invention, a computer readable medium stores a program of instructions. Execution of the program of instructions a processor configures an apparatus to at least send an authorization request for use of shared spectrum resources for a node of a wireless communications network. The authorization request includes at least an identification of the shared spectrum resource. Upon receiving an authorization acceptance, active timers relating to usage of the specified spectrum resource are stopped and use of the specified spectrum resource by the node is activated. A timer is activated, during pendency of which the authorized spectrum resource may be used. The timer runs during the duration of a grant time received in the authorization acceptance.

### BRIEF DESCRIPTION OF THE DRAWINGS

FIG. 1 illustrates a network according to an embodiment of the present invention;

FIGS. 2-5 illustrate signaling and operation diagrams according to embodiments of the present invention; and

FIGS. 6 and 7 illustrate elements that may be used in carrying out embodiments of the present invention.

### DETAILED DESCRIPTION

Embodiments of the present invention address the need to manage use of a shared spectrum resource by secondary users while taking into account the fact that a primary user may statically or dynamically allocate the spectrum resource for its own use. For example, a primary operator may define static rules specifying its own use (such as a defined zone or time where the spectrum is reserved to the primary user) or dynamic rules (such as vacating or re-offering of spectrum depending on the spectrum usage of the primary user, such as the incumbent in an ASA/LSA scenario). In both cases, zones where spectrum use under ASA/LSA is not allowed by one secondary operator or another are defined according to factors such as geographical area, time, and transmitter/receiver characteristics. In addition, vacating and activation lead time (time between issuing of a request to vacate or use ASA/LSA spectrum and acting on the request) may be defined as another input parameter to the mobile network operator (MNO).

ASA/LSA uses two basic mechanisms in the radio access network (RAN): configuration of all necessary parameters at base stations; and activation and deactivation of ASA/LSA spectrum at base stations. Both mechanisms are typically based on operation and maintenance tasks using a push or pull mechanism between base stations and operations support system (OSS) infrastructure.

As an ASA/LSA licensee, a secondary operator has to perform appropriate measures in the network (for example, reconfiguring or switching on and off the ASA/LSA spectrum usage of specific base stations) without violating the defined lead time in case of spectrum resource reservation actions triggered by the incumbent. Embodiments of the present invention provide a reliable, cost-effective solution.

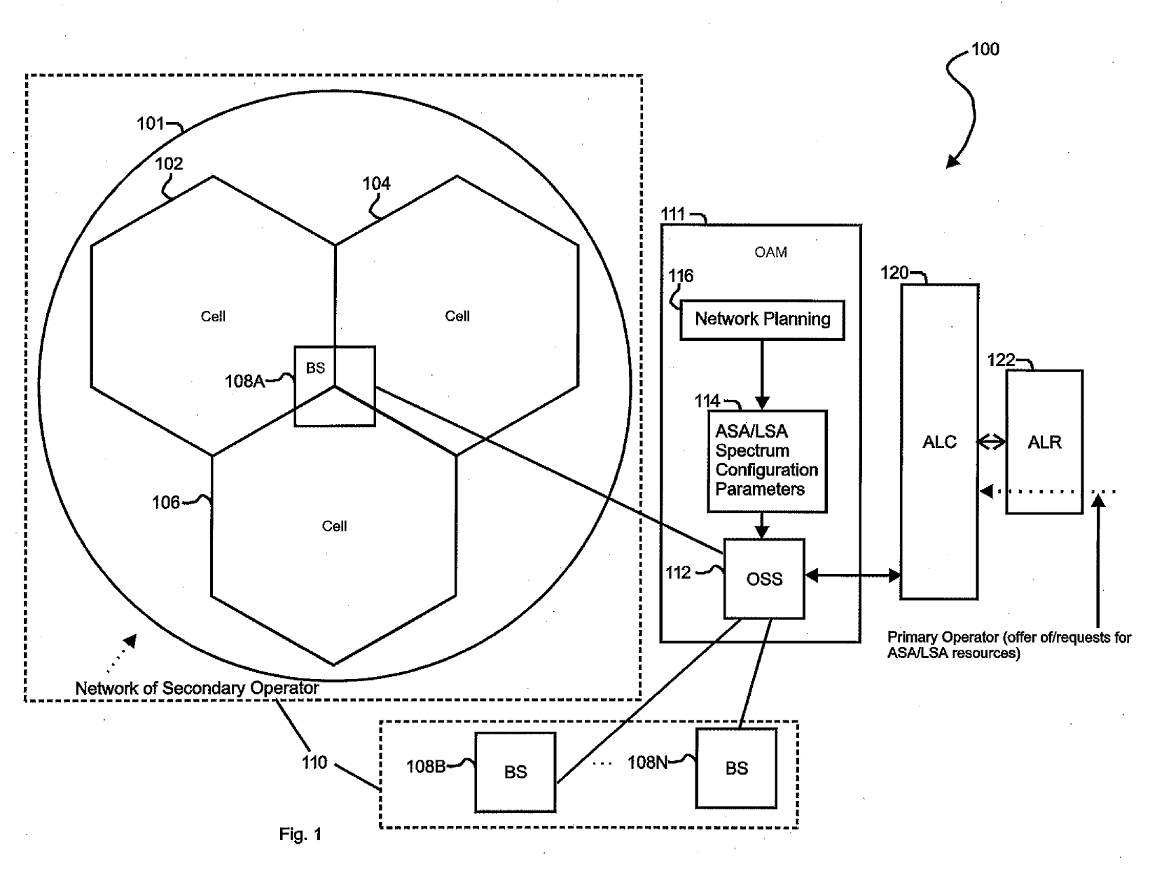

FIG. 1 illustrates a network configuration 100, comprising elements associated with a mobile network operator receiving access to shared resources and with a primary user granting access to the shared resources. The network configuration comprises a radio access network 101 comprising sectors 102, 104, and 106, each of which comprises an independent cell, defined by a base station 108A. Base stations 108B, . . . , 108N are also present, defining their own cells, but these cells are not shown in FIG. 1, in order to simplify the illustration and discussion. These sectors make up a license zone 110. If the primary user needs to use the ASA/LSA spectrum inside the license zone 110, it is necessary to activate or deactivate use of the ASA/LSA spectrum based on directions from the primary user. Additional network infrastructure comprises an operations, administration, and management (OAM) structure 111, including operation support services 112. The operation support services 112 receive ASA/LSA spectrum configuration parameters 116 from network planning 114. Planning input is received from an ASA/LSA control (ALC) 120 and ALR 122, which exchange ASA spectrum usage rules and management information. The ALC 120 exchanges information with the OSS 112. The ALC 120 receives offers of and requests for ASA/LSA resources from the primary operator, includes appropriate information and requests in its communications with the OSS based on the offers and requests.

One or more embodiments of the present invention provide for a self management function for the OAM, implementing a protocol between base stations of a radio access network and a network controller. The protocol allows flexible triggering and configuration of self-management procedures. The self-management procedures provide mechanisms to direct usage of local ASA/LSA resources at each base station through the use of a grant time mechanism. The grant time mechanism is based on a periodic authorization function, supported by variable timers configured with information exchanged via the protocol.

Base stations such as the base stations 108A, . . . , 108N of the network 100 are preconfigured to use ASA/LSA spectrum in specified ways, and are also preconfigured so as to govern their reactions to requests initiated by the primary operator to vacate ASA/LSA spectrum or other requests or offers of ASA/LSA spectrum. The secondary operator may use parameters relating to the ASA/LSA spectrum of the data usage of the primary operator and the data of its own network 100 to start network planning for its usage of the ASA/LSA spectrum. This network planning involves determining configuration parameters for each base station. The cells using the ASA/LSA spectrum (the cells 102, 104, and 106 in FIG. 1) are configured with these parameters via the OAM system 111 of the secondary network operator. As a result the network 100 is ready to use the ASA/LSA spectrum, but the ASA/LSA spectrum use has not yet been activated.

The ASA/LSA spectrum needs to be activated or deactivated according to the offer/request ASA/LSA resource input of the primary operator. Base stations such as the base stations 108A-108N employ a local self management function that initiates an authorization request for the use of the ASA/LSA spectrum. The authorization request is sent to the ALC, which represents a network controller in the ASA/LSA architecture. Alternatively, a SON Server or a similar network element that connects to the ALC may be used as network controller. In the latter case the ALC is used as a network function whenever ASA/LSA related information that is stored at the ALR is needed. For simplicity the further description assumes that the ALC is used as network controller. The ALC checks either by querying the ALR or through the use of already available local data whether or not the ASA/LSA spectrum for the respective cell of the base station is available for use and, if the ASA/LSA spectrum is available, answers the Authorization Request with an Authorization Accept. If the ASA/LSA spectrum is not available, the ALC answers the Authorization Request with an Authorization Reject. Additionally a flexible lease function may be included in the self management function at the base station. The flexible lease function is directed by dynamic grant times that are calculated at the network controller/ALC. The grant times may be added as parameters to the Authorization Accept and Authorization Reject answers to inform the self management function at the base station about the authorized usage time for the ASA/LSA spectrum.

Due to different ASA/LSA spectrum usage scenarios the grant times needs flexible realization options. Following time parameters are used to provide the required support:
ta: grant time for each cell with activated ASA/LSA spectrum. The ASA/LSA spectrum can be used by the cell until the timer ta expires. In general the timer ta is related to the lead time: for example, the timer ta always has a lesser value than the lead time. To guarantee a seamless ASA/LSA usage for the cell, the BS must wait not longer than ta−n*tr, where n is a configured repeat factor and tr is the configured timeout parameter for an unanswered authorization request before a new authorization request for the ASA/LSA spectrum for the cell is initiated. The timer ta is restarted with the value ta received with the authorization accept for the cell and the ASA/LSA spectrum. In addition, the timer ta is reset when an authorization reject or a trigger event for reauthorization of the ASA/LSA spectrum is received.
td: wait time for each cell with deactivated ASA/LSA spectrum. The ASA/LSA spectrum is not available during this time for this cell. The BS must wait at least the time td before a new authorization request for the cell and the ASA/LSA spectrum is initiated. The timer td is restated with the value td received with the authorization reject for the cell and the ASA/LSA spectrum. In addition, the timer td is reset when an authorization accept or a trigger event for reauthorization of the ASA/LSA spectrum is received.
tr: supervision timer for an authorization request. When tr expires the authorization request is repeated n times, where n is a configured repeat factor, before either the grant time ta for the activated ASA/LSA spectrum is over and the cell must to deactivate the ASA/LSA spectrum or the wait time td for the deactivated ASA/LSA spectrum is over and the cell has to stay in deactivated ASA/LSA spectrum mode.
tt: wait time before a new authorization request is initiated for the ASA/LSA spectrum for the cell, when an authorization request has not been answered for n*tr.

In addition, a requested grant time tg may be used as an optional parameter in an authorization request. This parameter provides guidance for the self management processes of the base station in optimizing grant time handling according to ASA/LSA spectrum usage conditions. When ASA/LSA spectrum is needed due to performance reasons, a longer requested grant time value may be set, and when performance does not require the ASA/LSA spectrum, a shorter value may be set. In addition, requested grant time could be set to zero (tg=0) to inform the ALC 120 that the ASA/LSA spectrum use has been deactivated. This is important for dynamic ASA/LSA spectrum allocation and de-allocation use cases to inform the ALC 120 that a cell of a base station (such as the base station 108A) has ceased use of the ASA/LSA spectrum. The ALC may use the request grant time tg as a steering indicator to adjust the spectrum grant time ta and wait time td.

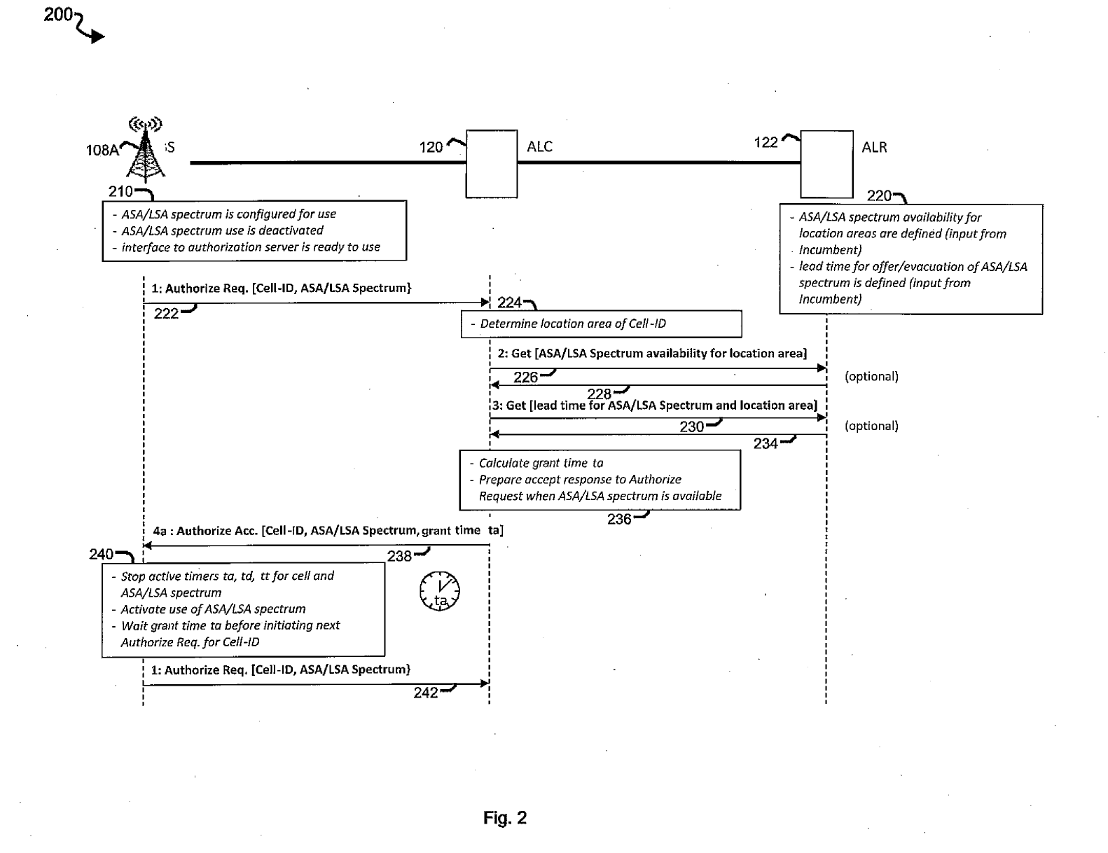

FIGS. 2, 3, and 4 below illustrate detailed operation and message flows of the authorization procedure for ASA/LSA spectrum use in a cellular network.

FIG. 2 illustrates the scenario when the ASA/LSA spectrum is available, showing the base station 108A, the ALC 120, and the ALR 122. At the initial condition 210 at the base station 108A, ASA/LSA spectrum is configured for use, but actual use is deactivated. The interface to the authorization server is ready to use. At the initial condition 220 of the ALR 120, ASA spectrum availability for location areas are defined (suitably based on information from the primary operator), and lead time for offering or vacating ASA/LSA spectrum is defined, again, suitably based on information from the primary operator.

The base station 108A sends an authorize request 222 to the ALC, with the authorize request 222 specifying the cell identifier and the ASA/LSA spectrum requested. At operation 224, the ALC 120 determines the location of the cell ID. The ALC 120 may optionally send a request 226 for ASA/LSA spectrum availability for the location area, with the ALR 122 returns this information in a message 228. The ALC 120 may optionally send a request 230 for lead time for offers of or vacating from the ASA/LSA spectrum for the location area, with the ALR 124 returning this information in a message 234.

Whether or one or both of the messages 226 or 230 are sent and their responses 228 and 234 received may be based on a detailed definition of ASA/LSA spectrum usage rules agreed upon between the secondary operator and the primary operator. For example, a configuration may be used in which offering and vacating of ASA/LSA spectrum is known in advance: for example, the primary operator may provide in advance a schedule during a specified time period, with the schedule specifying time intervals during which the spectrum is unavailable. In another configuration, ASA/LSA spectrum may be used by the primary operator in urgent situations, and in such a configuration, it may be specified that the ASA/LSA spectrum should be made available within a given time (for example, 5 minutes) after the secondary operator is informed about the urgent situation.

At operation 236, the ALC 120 calculates a grant time ta, and prepares an accept response to the authorization request. The ALC 120 sends an authorize accept message 238, providing the cell identifier, ASA/LSA spectrum information, and grant time. At operation 240, the base station stops active timers ta, td, and tt for cell and ASA/LSA spectrum, activates use of the ASA/LSA spectrum for the cell, and waits for the duration of the grant time ta before initiating the next authorization request for the same cell. Upon expiration of the grant time ta, the base station is able to make a new authorization request 242.

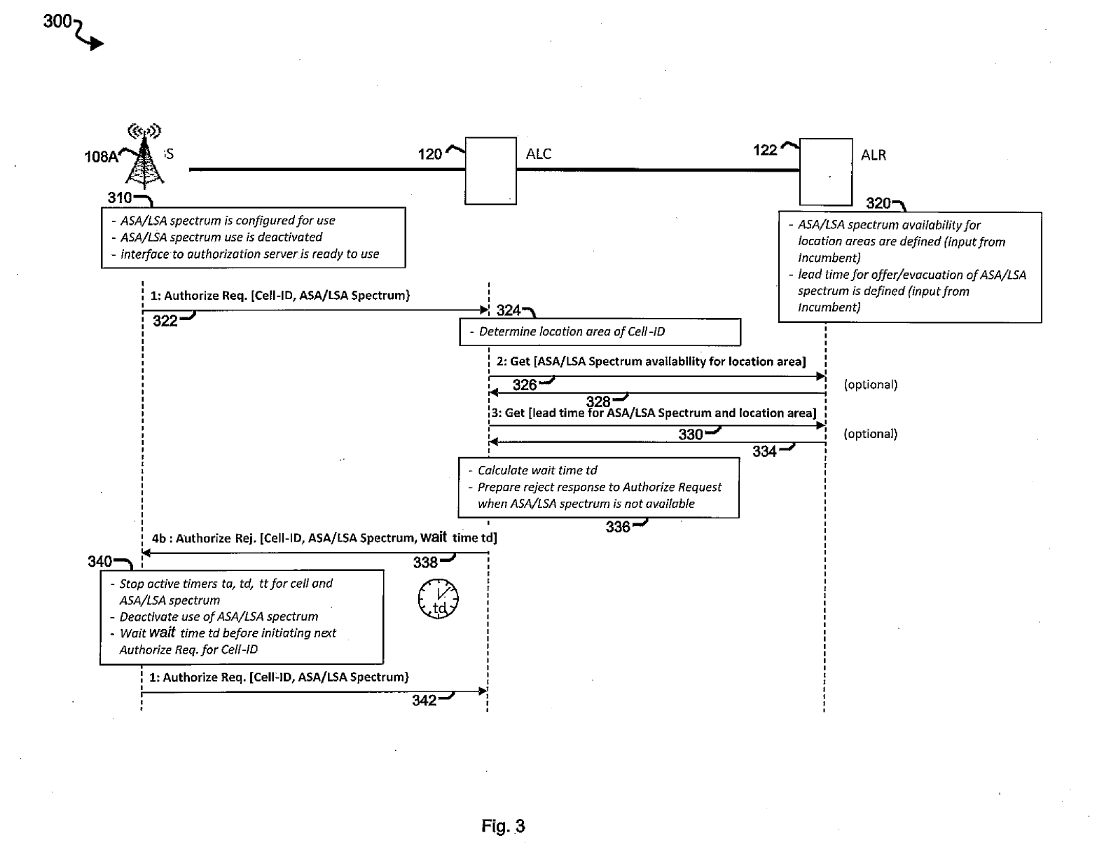

FIG. 3 illustrates the scenario when the ASA/LSA spectrum is available, showing the base station 108A, the ALC 120, and the ALR 122. At the initial condition 310 at the base station 108A, ASA/LSA spectrum is configured for use, but actual use is deactivated. The interface to the authorization server is ready to use. At the initial condition 320 of the ALR 120, ASA/LSA spectrum availability for location areas are defined (suitably based on information from the primary operator), and lead time for offering or vacating ASA/LSA spectrum is defined, again, suitably based on information from the primary operator.

The base station 108A sends an authorize request 322 to the ALC, with the authorize request 322 specifying the cell identifier and the ASA/LSA spectrum requested. At operation 324, the ALC 120 determines the location of the cell ID. The ALC 120 sends a request 326 for ASA/LSA spectrum availability for the location area, and the ALR 122 returns this information in a message 328. The ALC 120 may send a request 330 for lead time for offers of or vacating from the ASA/LSA spectrum for the location area, and the ALR 122 returns this information in a message 334. When the ALC 120 detects that the requested spectrum for the cell is not available, so at operation 336, the ALC 120 calculates a wait time td, and prepares a reject response to the authorization request. The ALC 120 sends an authorize rejection message 338, providing the cell identifier, ASA/LSA spectrum information, and wait time td. At operation 340, the base station stops active timers ta, td, and tt for cell and ASA/LSA spectrum, deactivates use of the ASA/LSA spectrum, and waits for the duration of the wait time td before initiating the next authorization request for the same cell identifier. Upon expiration of the wait time td, the base station is able to make a new authorization request 342.

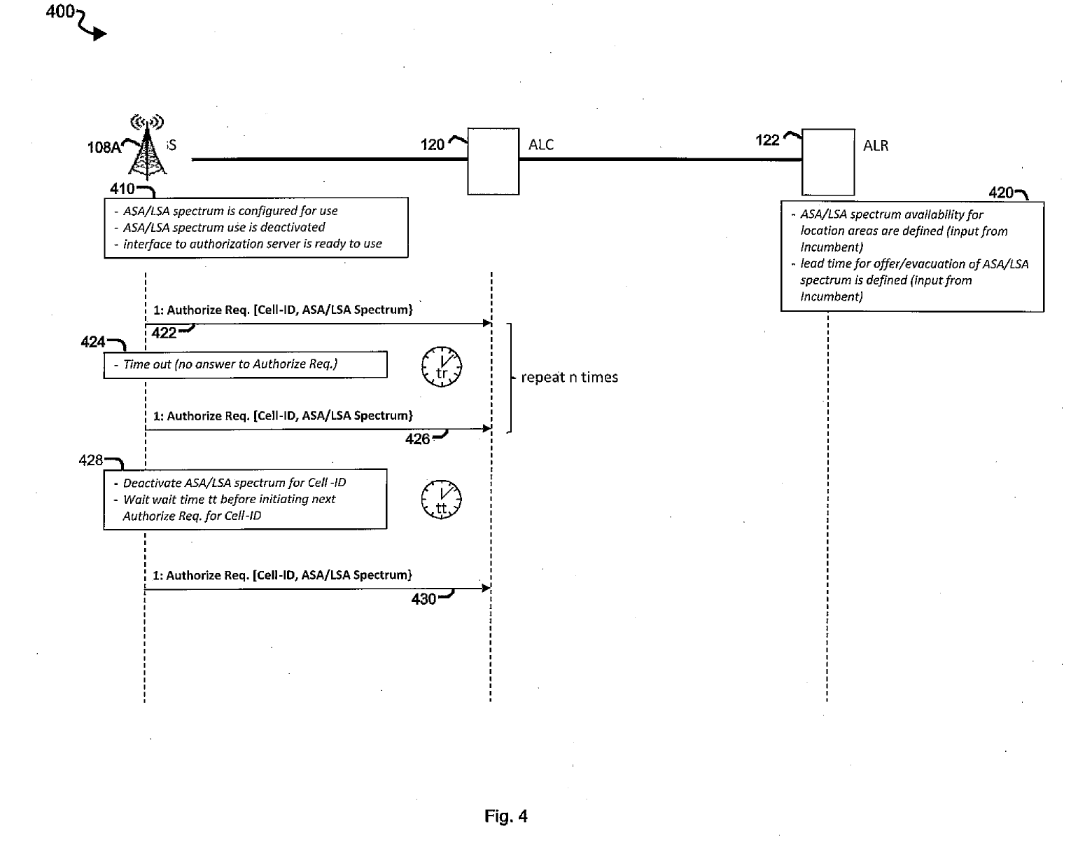

In some cases, network communication to a base station may fail altogether. In this case, a base station requesting ASA/LSA allocation will not receive any response at all. FIG. 4 illustrates such a scenario, showing the base station 108A, the ALC 120, and the ALR 122. At the initial condition 410 at the base station 108A, ASA/LSA spectrum is configured for use, but actual use is deactivated. The interface to the authorization server is ready to use. At the initial condition 420 of the ALR 120, ASA spectrum availability for location areas are defined (suitably based on information from the primary operator), and lead time for offering or vacating ASA/LSA spectrum is defined, again, suitably based on information from the primary operator.

The base station 108A sends an authorize request message 422 to the ALC 120, including Cell ID, and ASA/LSA spectrum request. No response is received, and the base station 108A performs operation 424, recognizing a timeout and sending another authorize request 426. Once this process has been repeated a specified number of times, the base station recognizes a failure. Then, the base station 108A performs operation 428, deactivating the ASA/LSA spectrum for the specified cell ID and waiting for a specified time tt before initiating a new authorize request. Once time tt has elapsed, the base station 108A sends a new authorize request 430.

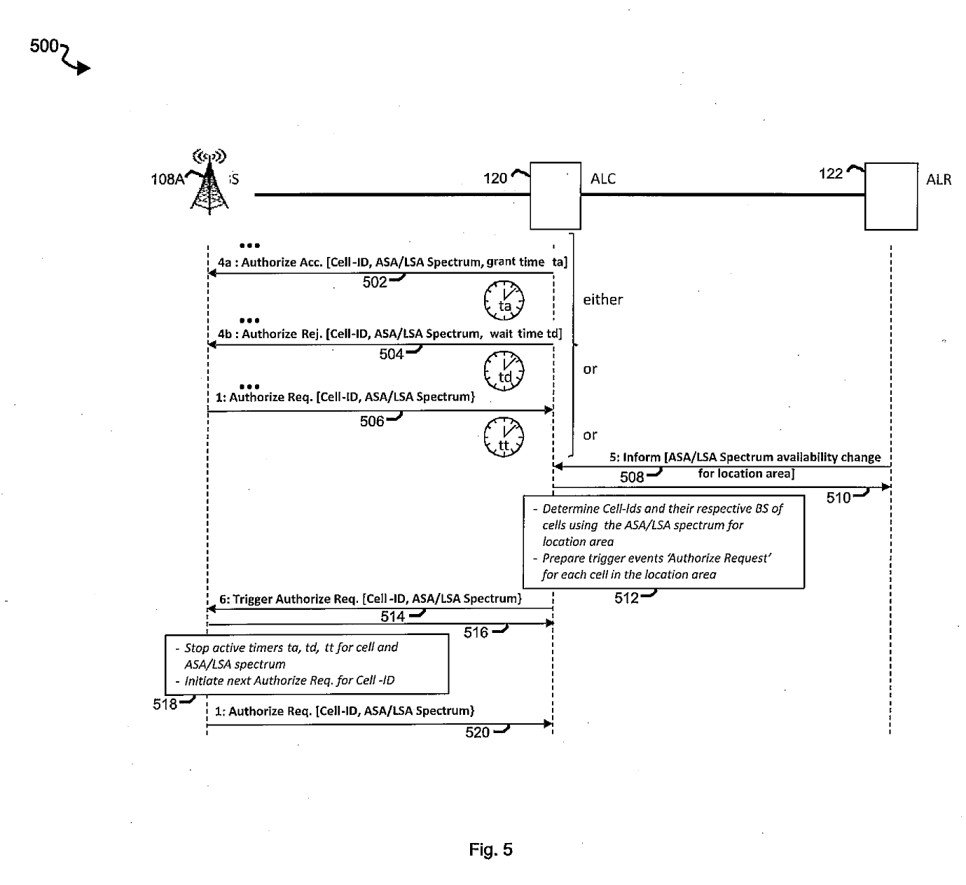

FIG. 5 illustrates a further embodiment 500, configured to optimize shared spectrum grant handling (for example, minimizing the signal traffic needed for requesting spectrum authorization and responding to the requests in sharing scenarios where the spectrum is only sporadically used by the primary operator. In the illustrated embodiment, the protocol between the base station 108A and the ALC 120 uses a trigger mechanism to initiate a forced re-authentication for ASA/LSA spectrum. In such situations it is possible to introduce grant times ta that are even greater than the lead time. In any case 502, 504, or 506 where a timer ta, td, or tt is already running, the ALR 122 may inform the ALC 120 via a push or pull mechanism 508 and 510 that the availability of a ASA/LSA spectrum resource has changed due to the reservation actions of the primary operator. The ALC 120 performs operation 512, determining cell identifiers and their respective base stations for cells using the ASA/LSA spectrum for the location area, and preparing a trigger event for each cell in the location area. The ALC 120 sends an authorize request trigger message 5.14 to the base station 108A, including cell identifier and spectrum information, and the base station 108A returns an acknowledgement 516. The base station 108A performs operation 518, stopping the active timers ta, td, and tt for the specified cell and ASA/LSA spectrum, and initiating the next authorize request for the cell identifier and the ASA/LSA spectrum. The base station 108A then sends an authorize request message 520 to the ALC 120, including the previously specified cell identifier and ASA/LSA spectrum indication. The authorize request trigger message 514 may include a single cell identifier or a list of cell identifiers that belong to a base station.

In one or more embodiments of the invention, the time parameters ta, td, tg, and tt in the authorization messages may be used at a global level (with all cells receiving the same value) or at a cell-specific level (with each cell receiving an individually determined value). The grant time mechanism may also be used for dynamic ASA/LSA spectrum allocation and de-allocation to allow a base station to inform the ALC about unused ASA/LSA spectrum. The base station sends an Authorization Stop message for the cell identifier and specified ASA/LSA spectrum and the ALC answers with an Authorization Stop Accept message for the Cell-ID and ASA/LSA spectrum. A wait timer may be optionally used but is not necessary because the Base Station may initialize an Authorization Request whenever needed (for example, when a cell load violates a specified limit).

In one or more embodiments of the invention, interactions between network elements may be performed using the IETF RADIUS protocol, with the base station acting as a Radius client and the ALC as a Radius server. Radius Access Request and Response messages may be used to achieve the authorization request and response messages, with the parameters may be mapped to vendor-specific attributes. The following table illustrates one example of relation between and usage of Radius messages:

| | ASA/LSA Authorization | |
|---|---|---|
| Radius message | message | Remark |
| Access Request | Authorize Request | Access Request is used to |
| | | authenticate the BS and to |
| | | Request the ASA/LSA |
| | | spectrum, timer tg may be |
| | | used to actively inform the |
| | | ALC about need for |
| | | ASA/LSA spectrum |
| Access Request | Authorize Stop | special message with tg = 0 |
| (tg = 0) | | information to inform |
| | | ALC that the ASA/LSA |
| | | spectrum is deactivated |
| | | for a specific cell, the |
| | | message is especially used |
| | | in dynamic ASA/LSA |
| | | spectrum allocation and |
| | | de-allocation use cases |
| Access Accept | Authorize Accept | Authorize Accept, |
| Access Reject | Authorize Reject | Authorize Reject and the |
| | | optional Authorize Stop |
| | | Accept are covered by the |
| | | Access Accept and Access |
| | | Reject Radius messages |

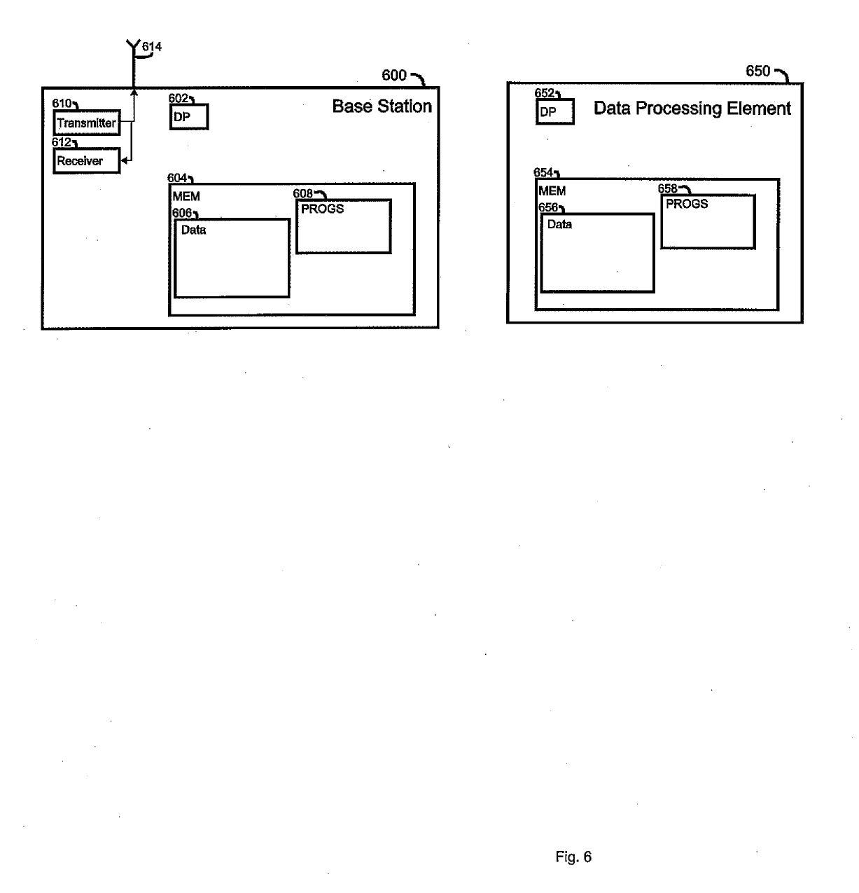

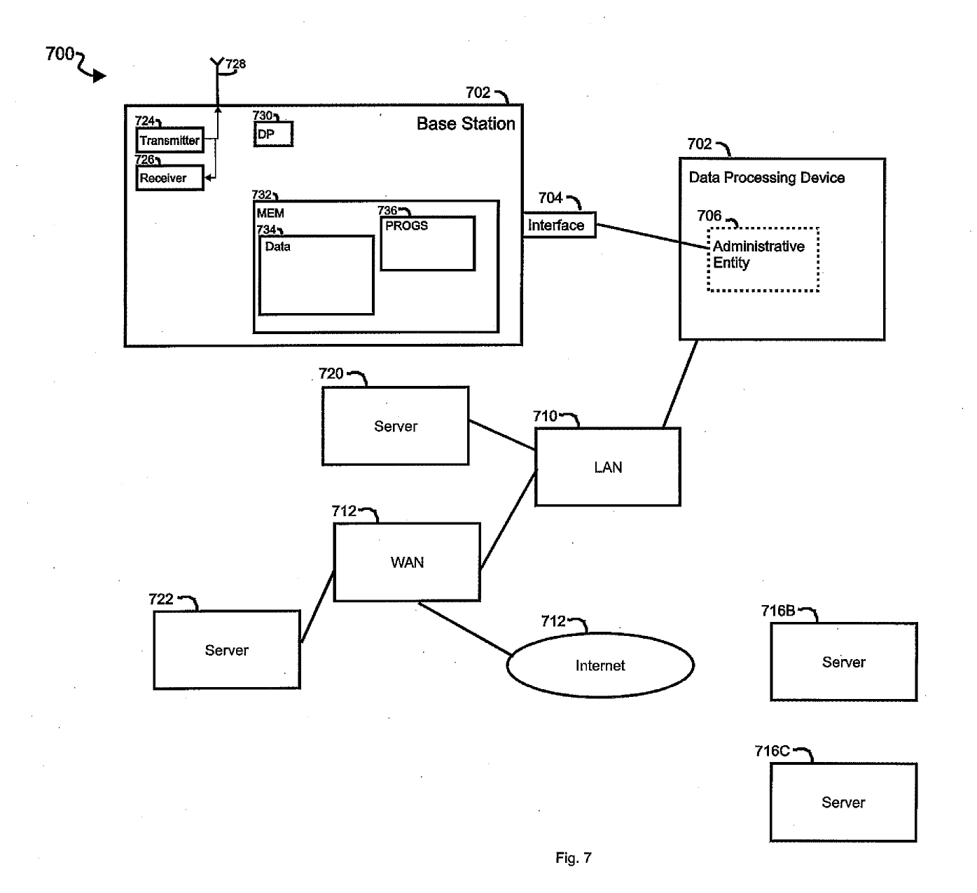

FIG. 6 illustrates a base station 600 and a data processing element 650, such as may be used in embodiments of the present invention. The base station 600 may be used, for example, in networks operated by the primary and secondary operators, and the data processing element 650 may be used in various elements of and to perform various functions a core network. The base station 600 comprises a data processor (DP) 602 and memory (MEM) 604, with the memory storing data 606 and one or more programs (PROGS) 608. The base station 600 may communicate using a transmitter 610 and receiver 612, using an antenna 614. The data processing element 650 comprises a data processor (DP) 652 and memory (MEM) 654, with the memory storing data 656 and one or more programs (PROGS) 658. At least one of the PROGs 608 in the base station 600 is assumed to include a set of program instructions that, when executed by the associated DP 602, enable the device to operate in accordance with the exemplary embodiments of this invention, as detailed above. In these regards the exemplary embodiments of this invention may be implemented at least in part by computer software stored on the MEM 604, which is executable by the DP 602 of the base station 600, or by hardware, or by a combination of tangibly stored software and hardware (and tangibly stored firmware). Similarly, at least one of the PROGs 658 in the data processing element 650 is assumed to include a set of program instructions that, when executed by the associated DP 652, enable the device to operate in accordance with the exemplary embodiments of this invention, as detailed above. In these regards the exemplary embodiments of this invention may be implemented at least in part by computer software stored on the MEM 654, which is executable by the DP 652 of the data processing element 650, or by hardware, or by a combination of tangibly stored software and hardware (and tangibly stored firmware). An electronic device implementing these aspects of the invention need not be the entire device as depicted at FIG. 1 or FIG. 6, or may be one or more components of same such as the above described tangibly stored software, hardware, firmware and DP, or a system on a chip SOC or an application specific integrated circuit ASIC. It should be noted that the invention may be implemented with an application specific integrated circuit ASIC, a field programmable gated array FPGA, a digital signal processor or other suitable processor to carry out the intended function of the invention, including a central processor, a random access memory RAM, read only memory ROM, and communication ports

The MEMs 604 and 654 may be of any type suitable to the local technical environment and may be implemented using any suitable data storage technology, such as semiconductor based memory devices, magnetic memory devices and systems, optical memory devices and systems, fixed memory and removable memory. The DPs 602 and 652 may be of any type suitable to the local technical environment, and may include one or more of general purpose computers, special purpose computers, microprocessors, digital signal processors (DSPs) and processors based on a multi-core processor architecture, as non-limiting examples.

In one or more embodiments of the invention, network nodes or base stations may be implemented as single local entities or a combination of local entities, as remote entities communicating with or controlling local entities, or in any appropriate combination of local and remote entities. Local or remote entities may be implemented in a distributed fashion, with functions being carried out through various processing elements allocated to particular tasks over a short or a long term. A network node such as a base station may be implemented as a data processing element, such as a server, host, or node, operationally coupled or otherwise connected to a remote radio head, and other data processing elements may be similarly implemented, without a connection to a remote radio head if wireless communication is not needed. It will also be recognized that data processing elements need not be operated as individual units, but may in some cases be implemented in the form of what may be thought of as virtual entities, with functions being distributed across multiple physical elements. Such physical elements may be organized under the control of software-based administrative entity serving as an interface to a user device or other element seeking service. The operations of any network node may be distributed in any desired fashion, whether by a single dedicated data processing element, through services allocated from a server which may provide services to a number of network nodes, or across servers or other data processing elements, with different functions being performed as needed based on any desired consideration. Some or all of the functions of a network node may be performed by one or more virtual machines, and a virtual machine may be commissioned or decommissioned based on various considerations relating to the operation of the data processing environment in which it is implemented, with all of these considerations being transparent to the network node. In some embodiments of the invention, virtual machines, data processing elements, and other entities carrying on the functions of a network node may be replaced by other elements as needed, without interrupting the operation of the network node. It will be recognized that in other embodiments a network node may be implemented as a single entity, and that different network elements may be implemented in different ways.

A network node 700 according to one or more embodiments of the invention comprises a remote radio head 702 connected by an interface 704 to an administrative entity 706. The administrative entity 706 may, be implemented in a local data processing device 708, which may be part of a local area network 710, and this local area network 710 may be part of or have access to a wide area network 712, which may provide access to the public Internet 714. The administrative entity 706 may enlist various data processing elements residing in various networks within or accessible to or through the local area network 710 and wide area network 712, or through the public Internet 714. For example, the Internet 714 may provide access to data processing servers 716A-716C, one or more of which may be made available for public use (for example, under the terms of a lease). The administrative entity 706 may use the data servers 716A-716C, servers 720 and 722 belonging to the local area network 710 and wide area network 712, respectively, or any other available data processing resources. Elements may be chosen from local or more remote elements based on, for example, latency considerations, and the administrative entity 706 may operate so as to maintain operational similarity between the node 700 and other similar nodes. The freedom provided by distributed operation allows the administrative entity to choose elements based on the specific operational characteristics that are to be achieved, without being unnecessarily restricted by the operational characteristics of any particular hardware entity. The various elements may be similar to the data processing element 650 of FIG. 6, with similar data processors and memory elements, storing data and operating the control of programs, similarly to the data processing element 650. The remote radio head 702 may include a transmitter 724, receiver 726, and antenna 728, and may include its own data processor (DP) 730 and memory (MEM) 732, with the MEM storing data 734 and at least one program (PROG) 736. In one or more embodiments of the invention, the local data processing device 708 may not be needed, and the remote radio head 702 may connect to the local area network 710 directly. In other embodiments, and for some network nodes, such as core network elements, no remote radio head is needed, and various data processing elements may be enlisted to serve the functions of the network node, using whatever local physical elements are needed to give the node a local presence and provide connection to other nodes.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

1. A method comprising:
receiving an authorization request for use of at least one spectrum resource in at least one specified area by a node of a wireless network communication system, wherein the node provides coverage for the at least one specified area, wherein the authorization request specifies at least an identifier that identifies the requested at least one spectrum resource; and
if use of the at least one spectrum resource is allowed, determining a grant time during which the spectrum resource is allowed to be used by the requesting node and sending an authorization request acceptance, wherein the authorization request acceptance includes the identifier and specifies the grant time.

2. The method of claim 1, further comprising, if use of the spectrum resource is not allowed, sending an authorization request rejection, wherein the authorization request rejection comprises information specifying a reason for the rejection and an action to be taken as a result of the rejection.

3. The method of claim 2, wherein the information specifying the reason for the rejection and the action to be taken is in the form of a reason code indexed to a member of a specified set of reasons and actions.

4. The method of claim 2, further comprising, if use of the at least one spectrum resource is not allowed, determining a wait time during which a request for use of the spectrum resource by the node is prohibited and sending an authorization request rejection, wherein the authorization request rejection includes the identifier, and specifies the wait time.

5. The method of claim 1, further comprising determining the spectrum resource based on the received identifier, determining spectrum resource availability, and determining lead time information for the spectrum resource, wherein the lead time information specifies time allowed between a notification from a primary operator offering or requesting vacating of the spectrum resource that is equal or includes the spectrum resource addressed by the identifier and response to the notification.

6. The method of claim 5, further comprising determining for an identifier a sequence of spectrum resources and respective lead times.

7. The method of claim 6, wherein the sequence is a hierarchy.

8. The method of claim 1, further comprising, if use of the spectrum resource is allowed, prohibiting a further authorization request until the expiration of the grant time.

9. The method of claim 4, wherein one or both of the grant time or the wait time are dynamically determined by a network controller based at least in part on rules set by a primary operator and by network conditions for the spectrum resource of a node for which authorization is requested.

10. A method comprising:
sending an authorization request for use of a spectrum resource in at least a specified area by a node of a wireless communications network, wherein the authorization request includes at least an identifier that identifies the spectrum resource;
upon receiving an authorization acceptance, stopping any active timers relating to usage of the specified spectrum resource, activating use of the specified spectrum resource, and activating a timer during pendency of which the spectrum resource may be used, wherein the timer runs during the duration of a grant time received in the authorization acceptance.

11. The method of claim 10, further comprising, upon receiving an authorization acceptance, stopping any active timers relating to usage of the specified spectrum resource, activating use of the specified spectrum resource, and activating a timer during pendency of which the spectrum resource may be used, wherein the timer runs during the duration of a grant time received in the authorization acceptance.

12. The method of claim 10, further comprising, upon failing to receive a response to the authorization request:
repeating the request after a specified timeout interval has elapsed, with the repetition continuing over a specified number of repetitions;
after the specified number of repetitions, deactivating the spectrum resource usage for the cell and waiting for a specified response failure wait time before making a further authorization request.

13. An apparatus comprising:
at least one processor;
memory storing a program of instructions;
wherein the memory storing the program of instructions is configured to, with the at least one processor, cause the apparatus to at least:
receive an authorization request for use of at least one spectrum resource in at least one specified area by a node of a wireless network communication system, wherein the node provides coverage for the at least one specified area, wherein the authorization request specifies at least an identifier that identifies the requested at least one spectrum resource; and
if use of the at least one spectrum resource is allowed, determine a grant time during which the spectrum resource is allowed to be used by the requesting node and sending an authorization request acceptance, wherein the authorization request acceptance includes the identifier and specifies the grant time.

14. The apparatus of claim 13, wherein the apparatus is further caused to, if use of the spectrum resource is not allowed, send an authorization request rejection, wherein the authorization request rejection comprises information specifying a reason for the rejection and an action to be taken as a result of the rejection.

15. The apparatus of claim 14, wherein the information specifying the reason for the rejection and the action to be taken is in the form of a reason code indexed to a member of a specified set of reasons and actions.

16. The apparatus of claim 14, wherein the apparatus is further caused to, if use of the at least one spectrum resource is not allowed, determine a wait time during which a request for use of the spectrum resource by the node is prohibited and sending an authorization request rejection, wherein the authorization request rejection includes the identifier, and specifies the wait time.

17. The apparatus of claim 13, wherein the apparatus is further caused to determine the spectrum resource based on the received identifier, determine spectrum resource availability, and determine lead time information for the spectrum resource, wherein the lead time information specifies time allowed between a notification from a primary operator offering or requesting vacating of the spectrum resource that is equal or includes the spectrum resource addressed by the identifier and response to the notification.

18. The apparatus of claim 17, wherein the apparatus is further caused to determine for an identifier a sequence of spectrum resources and respective lead times.

19. The apparatus of claim 18, wherein the sequence is a hierarchy.

20. The apparatus of claim 13, wherein the apparatus is further caused to, if use of the spectrum resource is allowed, prohibit a further authorization request until the expiration of the grant time.

21-36. (canceled)
